(19) United States
(12) Patent Application Publication
(10) Pub. No.: US 2023/0056126 A1
(43) Pub. Date: Feb. 23, 2023

(54) METHOD AND SYSTEM FOR THE METAL COATING OF A BORE WALL

(71) Applicant: Sturm Maschinen- & Anlagenbau GmbH, Salching (DE)

(72) Inventors: Marc KESTING, Straubing (DE); Roland BAIER, Bad Abbach (DE)

(73) Assignee: Sturm Maschinen- & Anlagenbau GmbH, Salching (DE)

(21) Appl. No.: 17/904,363

(22) PCT Filed: Mar. 4, 2021
(86) PCT No.: PCT/EP2021/055470

§ 371 Date: Aug. 16, 2022

(30) Foreign Application Priority Data
Apr. 16, 2020 (EP) 20169797.6

(51) Int. Cl. C23C 4/134; C23C 4/16; C23C 4/08

(52) U.S. Cl. CPC C23C 4/134; C23C 4/16; C23C 4/08

(57) ABSTRACT

The invention relates to a method and a system for the metal coating of a bore wall of a bore in a workpiece by means of atmospheric plasma spraying, wherein a coating lance having an anode and a cathode is moved axially into the bore and, in doing so, is rotated about its longitudinal axis, between the anode and the cathode an arc is produced, into which a plasma gas mixture is introduced and ionized, wherein a plasma flow is produced, a coating powder is supplied into the plasma flow and the plasma flow with the particles is sprayed onto the bore wall and on the bore wall a coating is formed. According to the invention provision is made in that the coating lance is moved into the bore at an axial feed speed and is rotated at a rotational speed of 420 rpm to 520 rpm and, at a volume flow of plasma gas mixture of 30 l/min to 70 l/min, coating powder is injected at a supply rate of 90 g/min to 130 g/min.

The invention relates to a method for metal coating, wherein a coating lance having an anode and a cathode is moved axially into the bore and, in doing so, is rotated about its longitudinal axis, between the anode and the cathode an arc is produced, into which a plasma gas mixture is introduced and ionized, wherein a plasma flow is produced, a coating powder is supplied into the plasma flow and the plasma flow with the particles is sprayed onto the bore wall and on the bore wall a coating is formed, in accordance with the preamble of claim 1.

Furthermore, the invention relates to a system for the metal coating of a bore wall of a bore with a coating lance having an anode and a cathode, wherein the coating lance can be moved axially into the bore and, in doing so, can be rotated about its longitudinal axis, a current source, through which, between the anode and the cathode, an arc can be produced, into which a plasma gas mixture can be introduced via an introduction means, the said plasma gas mixture being ionized in the arc to produce a plasma flow, a supply means for supplying a coating powder into the plasma flow and an injection nozzle which is directed to the bore wall, wherein by the plasma flow a coating is formed on the bore wall, in accordance with the preamble of claim 13.

Especially in engine production it is necessary to provide the running surfaces of cylinder bores with a specific metal coating to ensure adequate friction and lubrication conditions between the cylinder running surface and a cylinder piston. This is especially the case if both the engine housing and the cylinder piston are manufactured of the same metal, such as aluminum.

For this purpose, it is known that a bore wall is provided with a specific coating. For such a coating different methods are known, such as the so-called flame spraying, laser spraying, plasma transferred arc welding or arc spraying with melting wire electrode. A particularly efficient application of a coating is the so-called atmospheric plasma spraying. In a burner lance a plasma flow with a high temperature of up to 2000 K or more is produced by means of an arc and the introduction of a conveying gas. Into this hot plasma flow fine coating particles can be introduced that melt in the plasma flow and are applied with the plasma flow at high speed onto the bore wall.

A generic method and a generic system can be taken from EP 2 933 352 A1 for example.

When applying the coating it is essential that this is of stable design. Especially when used in engine production this has to have a long service life of many years, whereby the coating is exposed to high thermal, mechanical and chemical stress. The detachment of even smaller parts of the coating can lead to severe engine damage.

The invention is based on the object to provide a method and a system, with which a metal coating can be applied efficiently onto a bore wall.

In accordance with the invention the object is achieved on the one hand by a method having the features of claim 1 and on the other hand by a system having the features of claim 13. Preferred embodiments of the invention are stated in the dependent claims.

The method according to the invention is characterized in that the coating lance is moved into the bore at an axial feed speed and is rotated at a rotational speed of 420 rpm to 520 rpm and, at a volume flow of conveying gas of 30 l/min to 70 l/min, coating powder is injected at a supply rate of 90 g/min to 130 g/min.

According to the invention the realization was made that for the production of a particularly advantageous coating the ratio between the rotational speed of the burner lance in the bore and a supply rate of coating powder is the decisive factor. In the method according to the invention provision is made for a relatively high conveying rate of 90 g/min to 130 g/min while a moderate rotational speed of 420 rpm to 520 rpm is provided. In this way, a relatively strong material application per revolution takes place, whereby, according to a finding of the invention, this is advantageous for a microporous composition of the coating. At the same time, the coating particles are sufficiently melted at least on their exterior such that they form a solid bond. With an increased supply rate per revolution in the indicated setting range the degree between melting and rapid cooling proves to be particularly advantageous, thus resulting in a desired microporous layer composition. This is promoted further by setting the conveying gas in a range of 30 l/min to 70 l/min.

A preferred embodiment of the method resides in the fact that an axial feed speed of 3.8 mm/rev to 4.5 mm/rev, in particular 4.1 mm/rev to 4.2 mm/rev, is set. This results in an especially stable layer composition with the desired structure. It is particularly preferred if the axial feed speed amounts to 4.13 mm/rev.

According to a further development of the invention a particularly good heating-up of the plasma flow is accomplished in that between the anode and the cathode a discharging current of 300 A to 400 A, in particular of 360 A, is set.

A good surface application onto the bore wall is furthermore achieved in that the plasma flow with the particles is sprayed on with an injection nozzle having a diameter of 1 mm to 2 mm, preferably of 1.5 mm. The lance is located in the center of the bore which preferably has a diameter of 7 cm to 15 cm. Apart from a cylindrical nozzle use can also be made of a flat nozzle with the same or a similar opening surface that can have a size of 1 mm by 3 mm for example.

For a targeted application of material it is advantageous with regard to the relatively large axial feed motion that the injection nozzle is inclined upwards with respect to the longitudinal axis by 5° to 20°, in particular between 8° and 12°, by particular preference by 10°. In this way, a substantially radially directed application of material can be realized since the inclination can compensate for a deviation caused by the axial feed motion.

Basically, the coating can be carried out in a single axial application. According to a method variant pursuant to the invention an especially stable structure of the coating can be achieved in that the coating is built up by several coating layers, in particular three to six coating layers, wherein a coating layer is in each case formed by an axial pass of the coating lance. It is particularly advantageous if four axial passes are carried out with the coating lance over the bore wall.

An especially stable coating results, in particular, from the fact that a layer thickness of 150 μm to 300 μm, in particular of 250 μm is formed. In the case of four passes a layer thickness ranging between 60 μm and 70 μm can thus be applied in particular.

The plasma gas mixture can basically be formed in any chosen way. According to a further development of the invention it is particularly advantageous that the plasma gas mixture is formed by using argon, hydrogen, nitrogen and/or helium. These elements result in a particularly effective plasma flow for the coating method. The coating powder can be conveyed by a carrier gas.

With regard to the speed of the coating lance it is especially advantageous that a rotational speed of 450 rpm to 465 rpm, in particular of 459 rpm, is set. According to a finding of the invention a particularly good and stable application of material is accomplished in this speed range.

With regard to the plasma gas mixture a preferred setting range resides in that a volume flow of the plasma gas mixture of 40 l/min to 50 l/min, preferably of 44 l/min, is set. Through this, a good conveying effect can be achieved for the coating powder, while at the same time resulting in a necessary but not too high cooling-down of the plasma flow. Preferably, argon can in this case be employed with 40 l/min and hydrogen with 4 l/min in order to form the plasma gas mixture.

Furthermore, it is particularly expedient that the supply rate of the coating powder is set to 110 g/min. For the coating commercially available coating powder can generally be used for plasma spraying.

In conjunction with this it is especially advantageous that a coating powder having iron particles and/or further metals is used, wherein an average size of the particles ranges between 100 nanometers and 100 μm. It is particularly preferred that in the heated-up plasma flow these particles melt completely or incompletely, i.e. only on their upper surface, and thus have the shape of a drop when impinging on the coating wall. In this way, a coating can be composed of approximately spherical elements which form a coating structure with interposed micro free spaces through targeted cooling. In particular, this does not result in a continuous solid connection but the melted and cooling-down coating particles are only connected to each other in some areas, with preferably between 2% to 20% of the coating volume being formed by pore cavities.

The system according to the invention is characterized in that a control is provided and designed such that the coating lance can be moved into the bore at a uniform axial feed speed and can be rotated at a rotational speed of 420 rpm to 520 rpm and a volume flow of conveying gas of 30 l/min to 70 l/min and a supply rate of coating powder into a plasma flow of 90 g/min to 130 g/min is set.

1.-13. (canceled)

14. Method for the metal coating of a bore wall of a bore in a workpiece, in particular a running surface of a cylinder bore in an engine block, by means of atmospheric plasma spraying, wherein
a coating lance having an anode and a cathode is moved axially into the bore and, in doing so, is rotated about its longitudinal axis,
between the anode and the cathode an arc is produced, into which a plasma gas mixture is introduced and ionized, wherein a plasma flow is produced,
a coating powder is supplied into the plasma flow,
the plasma flow with the particles is jetted onto the bore wall and on the bore wall a coating is formed, and
the particles of the coating powder are melted in the plasma flow and a coating provided with micropores is produced,
wherein
the coating lance is moved into the bore at an axial feed speed and is rotated at a rotational speed of 420 rpm to 520 rpm and, at a volume flow of plasma gas mixture of 30 l/min to 70 l/min, coating powder is injected at a supply rate of 90 g/min to 130 g/min, an axial feed speed of 3.8 mm/rev to 4.5 mm/rev is set, and
the coating is built up by several coating layers, wherein a coating layer is in each case formed by an axial pass of the coating lance.

15. Method according to claim 14,
wherein
an axial feed speed of 4.1 mm/rev to 4.2 mm/rev is set.

16. Method according to claim 14,
wherein
between the anode and the cathode a discharging current of 300 A to 400 A, in particular of 360 A, is set.

17. Method according to claim 14,
wherein
the plasma flow with the particles is jetted on with an injection nozzle having a diameter of 1 mm to 2 mm, preferably of 1.5 mm.

18. Method according to claim 14,
wherein
the injection nozzle is inclined upwards with respect to the longitudinal axis by 5° to 20°, in particular between 8° and 12°.

19. Method according to claim 14,
wherein
the coating is built up by three to six coating layers.

20. Method according to claim 14,
wherein
a layer thickness of 150 μm to 300 μm, in particular of 250 μm is formed.

21. Method according to claim 14,
wherein
the plasma gas mixture is formed by using argon, hydrogen, nitrogen and/or helium.

22. Method according to claim 14,
wherein
a rotational speed of 450 rpm to 465 rpm, in particular of 459 rpm, is set.

23. Method according to claim 14,
wherein
a volume flow of the plasma gas mixture of 40 l/min to 50 l/min, preferably of 44 l/min, is set.

24. Method according to claim 14,
wherein
the conveying rate of the coating powder is set to 110 g/min.

25. Method according to claim 14,
wherein
a coating powder having iron particles and/or further metals is used, wherein an average size of the particles ranges between 100 nm and 100 μm.

26. System for the metal coating of a bore wall of a bore in a workpiece by means of atmospheric plasma spraying, in particular by a method according to claim 14, with
a coating lance having an anode and a cathode, wherein the coating lance can be moved axially into the bore and, in doing so, can be rotated about its longitudinal axis,
a current source, through which, between the anode and the cathode, an arc can be produced, into which a plasma gas mixture can be introduced via an introduction means, the said plasma gas mixture being ionized in the arc to produce a plasma flow,
a supply means for supplying a coating powder into the plasma flow and
an injection nozzle which is directed to the bore wall, wherein by the plasma flow a coating is formed on the bore wall,
wherein
a control is provided and designed to control the system for metal coating such that the coating lance is moved into the bore at a uniform axial feed speed of 3.8 mm/rev to 4.5 mm/rev and is rotated at a rotational speed of 420 rpm to 520 rpm and a volume flow of plasma gas mixture of 30 l/min to 70 l/min and a supply rate of coating powder into the plasma flow of 90 g/min to 130 g/min is set, and
the control is provided and designed to control the system for metal coating such that the coating is applied by way of several coating layers, in particular three to six coating layers, wherein a coating layer is in each case formed by an axial pass of the coating lance.
